(19) United States
(12) Patent Application Publication
(10) Pub. No.: US 2008/0083496 A1
(43) Pub. Date: Apr. 10, 2008

(54) Method for the dimensionally controlled bonding of surfaces

(75) Inventors: Philipp Smole, Buchs (CH); Johannes Edlinger, Feldkirch (AT); Alexander Bietsch, Ruschlikon (CH)

Correspondence Address: PEARNE & GORDON LLP, 1801 EAST 9TH STREET, SUITE 1200, CLEVELAND, OH, 44114-3108, US

(73) Assignee: Unaxis Balzers Ltd., Balzers (LI)

(21) Appl. No.: 11/382,777

(22) Filed: May 11, 2006

Related U.S. Application Data
(60) Provisional application No. 60/680,811, filed on May 13, 2005.

(51) Int. Cl. C09J 5/08

(52) U.S. Cl. 156/307.3; 427/207.1

(57) ABSTRACT

This invention introduces an improved method for bonding two surfaces using silk-screen printing technology. The method according to the invention reduces possible occlusion of the screen, thus improving the print quality of the deposited cement film. This is accomplished by adding particles to the print medium. In addition, by selecting the size of the particles it is possible for these, serving as spacers during the bonding process, to define the thickness of the cement layer. An additional procedural step describes the controlled mutual approach of the bonding surfaces.

### TECHNICAL APPLICATION

This invention relates to a method for the dimensionally controlled bonding of planar components. Specifically, it is aimed at providing a method by which structured components can be bonded quickly, at low cost and with a dimensionally defined cement layer.

### BACKGROUND

There are various ways to cement two or more elements together into one component. The significant steps consist of the application of the cement on at least one object bonding surface, the defined mutual approach of the elements and the fixation of the elements in their approach position, allowing the cement to cure.

a) Application of the Cement

There are different methods for applying the cement. The most common include the needle dispensing method, the so-called ink jet printing method and the so-called silk-screen method.

In needle dispensing, a cannula is moved across the object bonding surface at a close distance (approx. 100 μm) and the cement is squeezed through the cannula onto that surface. A major drawback here consists in the fact that it is a serial process, often making the application of the cement a very time-consuming affair. Cementing lengths of several meters takes a very long time. For example, a length of perhaps 3 meters can easily take 10 to 20 minutes. Conceivably, this method could employ several needles in parallel. However, even single-needle dispensing requires relatively extensive maintenance, making the use of multiple needles simply uneconomical.

A somewhat quicker solution, albeit not quick enough, is cement application by the ink jet method. It allows a bonding length of 3 meters to be applied within 5-10 minutes. The cement is applied in droplets, which poses two major problems. First, it is technically a difficult and complex task to produce droplets of a volume less than 10 nL. That limits the fineness of the cement traces, if a technically more complex system is to be avoided. Second, the portioned application often causes the droplets to run together in a jagged line, making this method unsuitable for some purposes.

Silk-screen or serigraphic printing is a popular method for applying cement on object bonding surfaces. In this case a screen, for instance a textile fabric, is masked and cement is applied through the screen onto the object bonding element. Here, a problem lies in the fact that, in practice, the use of a polymeric cement composition often leads to a gumming and clogging of the fabric used in silk-screen printing. Since a partial curing i.e. polymerization of the cement or the evaporation of the solvent already occurs on the screen, deposits will form in the mesh, clogging it up. That in turn results in an incomplete application of the cement. There have been attempts at solving this problem with an aqueous cement, as described for instance in EP 0 866 840. On the other hand, the intended use often dictates the type of cement to be employed, so that switching over to a different type of cement will not be easily possible.

b) Precise Joining of the Elements to be Bonded

Another step in the defined bonding process consists in the precise mutual approach of the object elements. While for some purposes it suffices to attach one element to the other, there are situations, especially in the case of optical components, where highly precise mutual positioning of the elements is imperative. Such positioning can include relative orientation, alignment and the defined distance between the two elements after completion of the bonding process. Obviously, in most cases, for the cement to develop its bonding strength it must have a certain thickness, even if minimal, at least in one area of the surfaces that are to be joined. That thickness, however, is often specifically dictated by the intended use. For example, the cement layer may have to be of a constant thickness of perhaps 2 μm, 5 μm or 10 μm.

To produce such a precisely dimensioned cement layer, the object elements must be brought together in a precisely defined manner. In most cases, however, and especially when large surfaces are involved and the assembly process must be relatively quick, it is necessary to apply pressure. But, often enough in the case of optical components, the clamping and uniform translational movement of the components can pose a problem. Mechanical pressure by tools would promptly damage the optical surfaces. Therefore, in some cases, the components are joined by capillary forces and/or gravity which, however, is a time-consuming and consequently expensive process.

It would therefore be desirable to find a method that would allow elements to be joined in gentle fashion but more quickly than through capillary forces or gravity.

c) Curing at a Fixed Distance

To obtain the precisely dimensioned cement layer it would have to be possible to stop the mutual approach of the elements at a precisely defined point. Moreover, it is most often necessary to keep the elements at a defined distance during the curing, given that the curing takes a certain time, yet many cement types tend to change their intrinsic volume during the curing. A defined distance can be maintained during the curing by various methods. For example, one or several of the object elements may first be provided with so-called fixed spacers. No cement is applied on these spacers, but when the elements are brought together, the spacers define the thickness of the cement layer. However, mounting such specific spacers makes the manufacturing process more complex and correspondingly expensive. As another possibility, so-called spacer balls can be added to the cement itself. These spacer balls, essentially of a specific diameter, are mixed directly into the cement, together with which they are applied on the object bonding surface. When the two elements are pressed against each other, there will remain a distance between them equivalent to the diameter of the spacer balls. Of course, in lieu of spherical spacers such as these spacer balls, other geometric shapes are possible as well, which is why the following will refer to them all merely as spacers. For both the needle dispensing method and ink jet bonding, spacers mixed in with the cement create a significant problem since they are prone to clogging up the cannulas or channels.

It would therefore be desirable to find a method that would allow these spacers to be used without creating the above-mentioned clogging problems.

### The Objective of this Invention

It is therefore the objective of this invention to introduce a bonding method which at least overcomes the above-described problems of prior art.

### The Solution According to this Invention

According to the invention, the solution consists in a method that builds on the method known in professional circles as silk-screen printing. One of the novel modifications involves the admixture to the cement of particles several micrometers in size. Tests have shown that, surprisingly, this not only does not completely clog up the screen but in fact significantly improves the silk-screening process. In other words, for the first time ever the silk-screen printing method can be implemented for the application of cement without any problem, i.e. without occlusion problems.

Another aspect is based on the fact that the dimensions of the added particles can be so chosen that they will function as spacers for the cement layer. This not only introduces an improved silk-screen printing method but also adds a feature to the cement that is important for maintaining the desired thickness of the cement layer. The following description refers to these added particles as spacers even in those cases in which they are not explicitly intended to maintain the thickness of the cement layer.

Yet another aspect of this invention is based on the fact that it introduces a method by which the joining of the two object bonding elements can be accelerated. Specifically, if one of the elements includes through-perforations or cavities that extend all the way to the other element to which it is to be bonded, the outer region of that interface can be sealed while the perforations and/or cavities can be subjected to a vacuum. The ambient atmospheric pressure will thus press one element against the other, evenly and without the need to have any other mechanical tool bear on the elements that are to be bonded.

### DESCRIPTION OF THE INVENTION

The following will describe detailed examples of this invention in the form of different embodiments and with reference to the attached figures.

### BRIEF EXPLANATION OF THE FIGURES

FIG. 1: Silk-screen printing system

FIG. 2: Silk-screen printing system, with the doctor blade halfway across

FIG. 3: Exploded view of equipment for the approach and fixation of elements to be bonded

### DETAILS OF THE INVENTION

The four key components required for silk-screen printing are: The print medium, the screen with emulsion areas (defining the pattern to be printed), the surface of a substrate to be imprinted, and a doctor blade that squeezes the print medium through the screen.

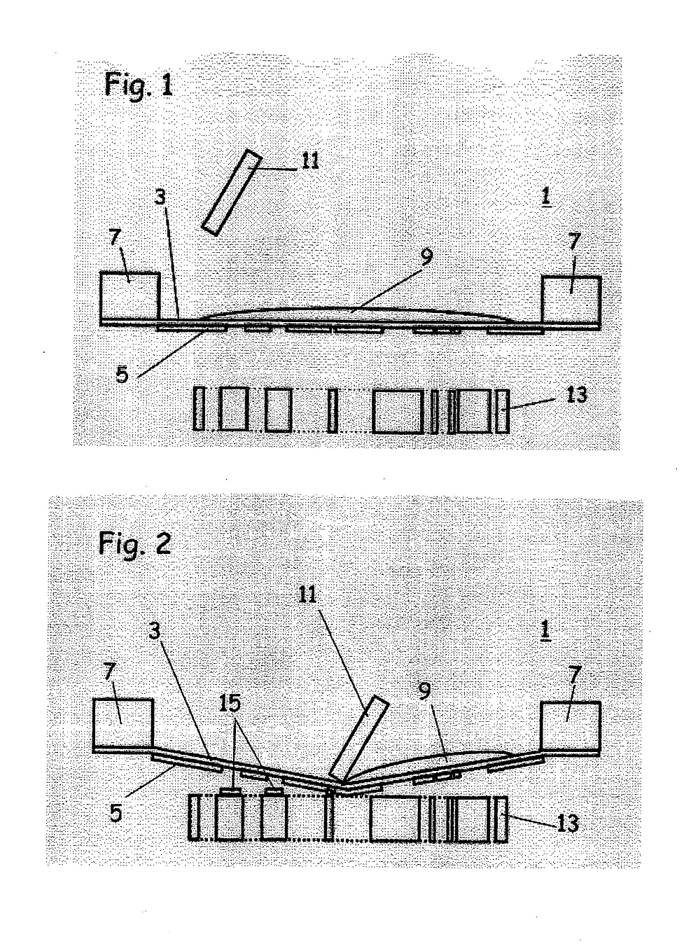

FIG. 1 is a schematic illustration of the components of a silk-screen printing system 1. The screen 3 encompasses emulsion areas 5 which determine on the screen those regions that are impermeable to the print medium. This ultimately defines the pattern that will be printed on the substrate surface. In the example shown that pattern is a square 60×60 cm frame, but it is entirely possible to use larger or smaller frames. The cleanly imprintable net surfaces will ultimately be about two thirds of the frame size. The screen is clamped on a frame made for instance of aluminum. Suitable screen materials include woven polyester or other textile-fiber material, or steel mesh, preferably of stainless steel. For the purpose of this description the term screen includes any and all forms of screen material including steel-wire mesh and other netting. The term “filament” refers in a very general sense to the constituents of the screen. The mesh size of the screen is specifically selected for the process at hand, with typical spacings of 60 μm to 300 μm, depending on the application. For the example shown a polyester fabric with a 100×100 μm² mesh was selected, with a filament diameter of about 40 μm. Other filament diameters between 30 μm and 200 μm can be useful as well, with the filament diameter obviously having to be smaller than the mesh size of the fabric. The filament diameter largely determines the density of the print-medium material that can be transferred to the element surface.

Masking of the screen 3 is accomplished by applying a photosensitive emulsion over a large area of the screen and then exposing it through a photomask. The emulsion may be a positive or negative photoresist. In the case of a positive photoresist the developing process will leave intact those areas that were not exposed, whereas those regions will be ablated that were exposed through the photomask. In the case of the negative photoresist the exact opposite applies. In either case the result is a fabric that contains emulsion-occluded regions through which no print medium can be squeezed, whereas the print medium can penetrate through the areas that are devoid of any emulsion. That emulsion as well affects the thickness of the medium applied on the surface of the object substrate. The emulsion causes that thickness to increase by up to 50%. This process permits the implementation of patterns whose smallest components may be about three times the mesh size of the screen employed. For smaller patterns the mesh would interfere with the printed image at least in some particular applications.

As a suitable adhesive print medium 9 according to the invention, epoxy resin is mixed with spacers. Alteratively, the adhesive component may be a UV-hardening, thermally hardening or multi-component chemically curing cement, or one that hardens through the evaporation of solvents. The example shown employs glass-bead spacers 5 μm in diameter. Other spacer sizes up to 80% of the mesh size are reasonably employable. Preferably, however, the maximum dimension of the spacers will not exceed 30% of the smallest dimension of the gaps defined by the mesh. The answer to the question of how high a concentration of spacers should be added is that it must be remembered that too high a spacer concentration will lead to a lumping of the spacers and thus to an occlusion of the screen. Desirable concentrations are between 0.5% and 80%. The preferred amount in the case of spherical spacers is 5%.

For the silk-screening process the screen 3, clamped onto the frame 7, is positioned about 5-10 cm above the target surface of the substrate 13. The screen 3 is aligned with the substrate 13 with the aid of a camera (not shown) that is moved between the substrate 13 and the screen 3, making it possible for instance by means of a beam-splitter prism to control and adjust the position of the screen 3 relative to the substrate 13. Once the alignment has been made, the camera is removed, and the screen is brought up to within a distance of between 0.5 mm and 5 mm, and preferably 2 mm.

Next, the print medium 9 in the form of the spacer-containing cement, preferably epoxy, is placed on the screen 3. Exerting pressure, a doctor blade 11 is then moved across the screen, squeezing the cement with its intermixed spacers through the mesh. Enough pressure must be applied to cause the part of the screen on which the doctor blade is bearing down to make contact with the object surface underneath that is to be imprinted, as shown in FIG. 2. Typical pressure levels are in the 0.2 N/cm range. Reference in this case is made to pressure per centimeter since the doctor blade is usually a kind of spatula. FIG. 2 shows the areas of the substrate 13 on which a structured pattern of cement 15 has been printed after the doctor blade has passed over it.

There are different ways in which the doctor blade can be moved across the screen. A one-time pass of the doctor blade across the screen is usually sufficient. However, there are also many reciprocating dual doctor blade systems in use.

After a structured film of cement has been deposited on the surface of an element, the two surfaces to be bonded must be brought together. When a surface is to be cemented along a specific pattern, the technician usually faces the requirement of creating precisely defined adhesive layer segments, meaning that the width and the thickness of the cement layer must be defined. Moreover, especially in the case of optical elements, bubble inclusions must be avoided. Bubble inclusions are usually caused by the silk-screen printing process itself, as well as by the conditions under which the two elements are joined. The inventors have found that bubble inclusions cannot be avoided merely by heating the applied cement layer to between 30° C. and 80° C., preferably 60° C. There is another condition to be met, whereby the ratio between the width of the applied cement film and its thickness must not exceed 20:1 at least along one dimension. This means that it is possible to deposit very long strips, for as long as the width of the strip does not exceed 20 times the thickness of the strip. Given the surface tension, heating the cement will then cause a degassing of the bubbles. Moreover, the above-described geometry will lead to a convexity in one dimensional direction so that, when the second element that is to be attached is brought up, there will essentially be no formation of bubble inclusions. Now when the two elements are brought together in a precisely defined manner and are ultimately pressed together, they will be joined up to a distance beyond which the spacers will not allow them to come in contact. In the example shown that is the 5 μm mentioned above.

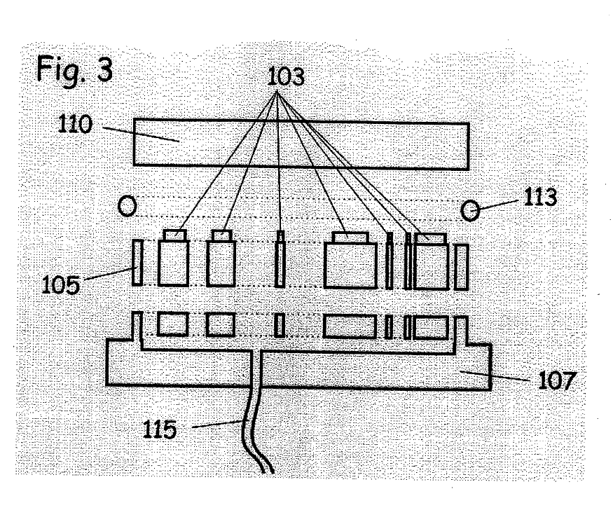

To be sure, when the elements are brought together, the pressure must be applied as evenly as possible. When precision-optical elements with an optical surface are to be cemented together, it will not be possible in many cases to simply press the object elements together with a tool. Another aspect of this invention is therefore dedicated to a method whereby the two elements can be joined in a desirable manner. A method of that nature is feasible when only one of the two elements is of a design whereby a relatively homogeneous channel distribution permits access to the surface of the other element. FIG. 3 is a schematic illustration of that configuration. According to the invention the structured element 105, provided with a cement film 103, is placed in flush contact on an adhesive support 107. The adhesive support contains channels which, by way of a valve, can be selectively connected to a pressure pump or to a vacuum pump. First, the pressure pump is used to generate a gas flow. Next, the second element 110 to be bonded is brought up to the cement film. The gas flow generates a gas cushion capable of suspending the second element without contact. This is usually where the so-called Bernoulli effect comes into play. When next the gas flow is gradually reduced to zero, the second element will be lowered onto the first element in controlled fashion. The cement film and the second element 110 now seal the channels from the environment. This is followed by connecting the channels to the vacuum pump. Opening the valve of the vacuum pump will displace the air from the channels, creating negative pressure. Since the channels are all interconnected, the result will be a well-balanced negative pressure. The pressure of the ambient air will press the second element 110 very evenly against the structured element 105 without the need for applying pressure on the second element by means of an additional tool. In a preferred embodiment the outer rim between the structured element 105 and the second element 110 is provided with an 0-ring gasket 113 that prevents the ambient air pressure from directly bearing on the cement films at the perimeter of the substrate that might otherwise push it inward.

This pressure system, of course, can be modified. For example, the base unit 107 can serve as the bottom section of a pressure chamber in which the structured element 103, the second element 110 and perhaps the gasket 113 can be pressurized, while the channel 115 on the base unit opens up to the ambient atmosphere, thus providing air pressure in the channels.

1. Method for applying a structured cement film on the surface of an element, encompassing the following steps:
preparing the surface of an element on which the structured cement layer is to be applied;
preparing a silk-screen printing system with screen and doctor blade, said screen encompassing sealed and unsealed regions;
applying a print medium on one side of the screen;
positioning said surface in non-contacting fashion near the screen in a manner whereby the screen is situated between the print medium and said surface;
squeezing the print medium through the screen using the doctor blade by brushing the doctor blade across the top of the screen, causing it to locally press the screen onto said surface and the print medium in the unsealed regions to be deposited on said surface;
characterized in that the print medium contains cement components as well as spacers.

2. Method as in claim 1, characterized in that a print medium is employed whose volume includes a spacer component at a concentration of between 0.5% and 80% but, preferably, approximately 5%.

3. Method for bonding at least 2 elements, characterized in that a first element is provided with a structured cement film according to the method described in claim 1 or 2, and that the surface of a second element is brought up to that of the first element to within a distance defined by said spacers, following which the cement film is allowed to cure.

4. Method as in claim 3, characterized in that the first element is provided with perforations leading to the surface to be bonded, that during the approach a gas flow is first generated in the direction of said surface which gas flow is reduced to zero during the approach and that, upon contact of the structured cement film with the surface of the second element, a negative pressure is generated in the said perforations in a manner whereby the ambient atmospheric pressure presses the second element against the first element.
